(19) United States
(12) Patent Application Publication
(10) Pub. No.: US 2012/0097730 A1
(43) Pub. Date: Apr. 26, 2012

(54) NAIL-PUSHING ROD RESTORING APPARATUS FOR PNEUMATIC NAIL GUN

(75) Inventors: CHIA-SHENG LIANG, Bali Shiang (TW); Chu-Hsiang Tseng, Bali Shiang (TW)

(73) Assignee: DE POAN PNEUMATIC CORP.

(21) Appl. No.: 12/908,033

(22) Filed: Oct. 20, 2010

(51) Int. Cl. B25C 1/04

(52) U.S. Cl. 227/130

(57) ABSTRACT

A nail-pushing rod restoring apparatus for a pneumatic nail gun includes a return air passage connected between a high-pressure main air chamber inside a gun body and a bottom cylinder chamber of a cylinder. A magnetic valve is disposed inside the gun body above the cylinder and located on the return air passage. An end of the magnetic valve is exposed inside a top cylinder chamber of the cylinder. The magnetic valve is lead by the piston to close the return air passage when the piston moves to the top of the cylinder. The magnetic valve is driven by the high-pressure air inside the top cylinder chamber to open the return air passage when the piston moves downward, so as to lead the high-pressure air inside the main air chamber to the bottom cylinder chamber to restore a nail-pushing rod after nail-pushing.

### BACKGROUND

1. Technical Field

The present invention relates to a nail-pushing rod restoring apparatus for a pneumatic nail gun. More particularly, the prevent invention relates to a nail-pushing piston inside the gun body of a nail gun and a valve for restoring the nail-pushing rod, where the valve and the piston may apply magnetic force on each other.

2. Related Art

Pneumatic nail gun is a handheld tool that uses high-pressure air as a source of momentum to perform nailing works. Generally speaking, outside the gun body there is a safety sliding rod, which can be pushed, for controlling nailing operation. Inside the gun body there are several main air chambers that can keep and concentrate high-pressure air at a constant pressure, a cylinder, a piston slidably mounted in the cylinder, a nail-pushing rod connecting to the bottom of the piston, and a trigger valve that drives the nail-pushing rod to pushing nails, etc. The piston divides the cylinder into a top cylinder chamber and a bottom cylinder chamber. A user can push the safety sliding rod against an object to be nailed, and press the trigger valve to switch the driving air passage for the high-pressure air inside the gun body. By so doing, the high-pressure air will enter the top cylinder chamber through the driving air passage, drive the nail-pushing rod to move down with the piston and shoot a nail. Afterward, the user needs to release the safety sliding rod and/or the trigger valve, so as to switch the driving air passage. By so doing, high-pressure air will enter the bottom air chamber, restoring the nail-pushing rod by moving it upward with the piston.

Furthermore, to control high-pressure air to drive the piston inside the cylinder to move downward for nail-pushing or move upward for restoration, the gun body of a traditional pneumatic nail gun is generally equipped with fixed or movable cylinders. Examples of nail guns that are equipped with fixed cylinders include U.S. Pat. Nos. 6,533,156, 6,779,699, and 6,006,975. According to each of these patents, a head valve is installed above a fixed cylinder. A trigger is used to drive high-pressure air to open a head valve, causing the high-pressure air to enter into the cylinder and drive a nail-pushing rod to move downward with a piston to shoot a nail. They also disclose a return air chamber that is located outside the cylinder and has a fixed volume, for guiding high-pressure air to the return air chamber for storage while the piston is moving downward for nail-pushing. This allows the limited high-pressure air in the return air chamber to be used to drive the piston up for restoration after the piston has moved down to a fixed position. However, the return air chamber can only accumulate the high-pressure air while the piston is moving downward to shoot a nail, and cannot maintain the high-pressure air at a constant pressure. As a result, the piston and the nail-pushing rod can only move at a speed that it less than optimal while being driven upward to restore their positions. Furthermore, when the nail-pushing rod is moving downward with the piston, the collection of high-pressure air, either split from the top cylinder chamber or remaining in the bottom cylinder chamber, inevitably imposes back pressure on the piston. This consumes or nullifies some the energy that would have been used in nailing, and negatively affects the efficiency and smoothness of the nail gun's operation.

U.S. Pat. Nos. 4,784,308, 4,319,705, and 4,294,391 disclose inventions that can alleviate the problem mentioned above. In addition to using designs (which are similar to the head valve design mentioned above) in which a valve is opened to drive a piston downward to shoot a nail, these inventions further use a movable cylinder to release the air remaining in the piston bottom cylinder chamber to the atmosphere, and to lead the high-pressure air into the bottom cylinder chamber to drive the piston upward for restoration. In addition, they disclose valve plugs of different forms but similar functions to replace the designs of the return air chamber. These valve plug designs can open the passage between the main air chamber and the bottom cylinder chamber when the trigger is released, so as to keep guiding the high-pressure air into the bottom cylinder chamber and drive the piston upward for restoration. However, because these kinds of valve plug elements are located inside the guy body farther away from the cylinder, they necessitate a bigger guy body volume and a more complicated flow-passage design. This makes it more complicated and more expensive to manufacture the gun body. Furthermore, because some elements are included in the movable cylinder inside the gun body, these designs make it more difficult to process the air passage in the gun body.

### BRIEF SUMMARY

One of the objectives of the present invention is to resolve the related arts' problems, which are discussed above.

To achieve this objective, the present invention provides a nail-pushing rod restoring apparatus for a pneumatic nail gun. The nail-pushing rod restoring apparatus includes a piston, a return air passage, and a magnetic valve. The top of the piston has an end surface suitable for being lead by magnetic force; the bottom of the piston has a nail-pushing rod. The return air passage is connected between a high-pressure main air chamber inside a gun body of the nail gun and a bottom cylinder chamber of a cylinder. The return air passage also passes above the cylinder and through the interior of the gun body. The magnetic valve is disposed inside the gun body above the cylinder and located on the return air passage. The magnetic valve controls the opening and closing of the return air passage. An end of the magnetic valve is exposed inside a top cylinder chamber of the cylinder and opposite to the end surface of the piston. The magnetic valve is lead by the piston to close the return air passage when the piston moves to the top of the cylinder. The magnetic valve is driven by the high-pressure air inside the top cylinder chamber to open the return air passage when the nail-pushing rod moves downward. This opened return air passage guides the high-pressure air inside the main air chamber to the bottom cylinder chamber, and the high-pressure air drives the nail-pushing rod back to restoration after the rod pushes a nail.

In view of the above, the magnetic valve can be disposed inside the top of the gun body and above the cylinder. This allows the magnetic valve to be located in the pre-existing space of the gun body inside a head valve of the nail gun, and reduces the complicity in modeling and drilling-processing the gun body. Furthermore, by reducing the gun body's volume while maintaining the cylinder pressure and volume, the nail gun will cost less and function better. In addition, this design is beneficial to the interaction between the magnetic valve and the piston, which can attract each other through magnetic force. Through the magnetic valve, the piston can control the open and close timing of the return air passage. This timing control ensures the operation stability of the magnetic valve, which is under the piston's control. Furthermore, because the single magnetic valve is used to control the timing that the high-pressure air at a constant pressure inside the main air chamber passes to the bottom cylinder chamber, the piston's function will not be negatively affected by back pressure. On one hand, this increases the speed and stability of the nail-pushing rod when it is moving upward with the piston to restore its position. On the other hand, this will not waste the energy of the nail-pushing rod when it is moving downward with the piston to shoot a nail. As a result, the nail gun can have a superior efficiency and smoothness in successive nailing.

The magnetic valve includes a valve chamber, a valve opening, and a magnetic valve bolt. The valve chamber is formed inside the gun body above the cylinder. An opening interconnects the valve chamber and the top cylinder chamber. On the inner wall of the valve chamber, the return air passage forms a first air hole connected to the main air chamber and a second air hole connected to the bottom cylinder chamber. The valve opening is formed on the inner wall of the valve chamber between the first air hole and the second air hole. The magnetic valve bolt is mounted inside the valve chamber slidably and located opposite to the end surface at the top of the piston. Inside the valve chamber the magnetic valve bolt has a first position for being lead by the piston to close the valve opening and a second position for being driven by the high-pressure air inside the top cylinder chamber to open the valve opening. The bottom of the magnetic valve bolt has a magnetic substance; through the opening the magnetic substance is exposed on the top of the top cylinder chamber.

The present invention further provides another nail-pushing rod restoring apparatus for a pneumatic nail gun. The nail-pushing rod restoring apparatus includes a magnetic piston, a return air passage, and a valve. The magnetic piston has a nail-pushing rod in its bottom. The return air passage is connected between a high-pressure main air chamber inside a gun body of the nail gun and a bottom cylinder chamber of a cylinder. The return air passage passes inside the gun body above the cylinder. The valve is disposed above the cylinder, inside the gun body, and located on the return air passage. The valve controls the opening and closing of the return air passage. An end of the valve has an end surface suitable for being lead by magnetic force. The end surface is exposed inside a top cylinder chamber of the cylinder and opposite to the end surface of the magnetic piston. The valve is lead by the piston to close the return air passage when the piston is moving to the top of the cylinder. The valve is driven by the high-pressure air inside the top cylinder chamber to open the return air passage when the nail-pushing rod is moving downward. Because the return air passage is opened, the high-pressure air in the main air chamber is guided to the bottom cylinder chamber, driving the nail-pushing rod to restore its position after nail-pushing.

In view of the above, the valve can be disposed inside the top of the gun body and above the cylinder. This allows the valve to be located in the pre-existing space of the gun body inside a head valve of the nail gun, and reduces the complicity in processing the gun body. Furthermore, by reducing the gun body's volume while maintaining the cylinder pressure and volume, the nail gun will cost less and function better. In addition, this design is beneficial to the reciprocal attraction between the valve and the magnetic piston. Thus, the magnetic piston can better control the valve, which then can better control the open and close timing of the return air passage. This timing control ensures the operation stability of the valve, which is under the magnetic piston's control. Furthermore, because the single valve is used to control the timing that the high-pressure air at a constant pressure inside the main air chamber passes to the bottom cylinder chamber, the nail-pushing rod will have a better speed and stability when moving upward with the magnetic piston to restore the original position. As a result, the nail gun can have a superior efficiency and smoothness in successive nailing.

The valve includes a valve chamber, a valve opening, and a valve bolt. The valve chamber is formed inside the gun body above the cylinder. An opening interconnects the valve chamber and the top cylinder chamber. On the inner wall of the valve chamber, the return air passage forms a first air hole connected to the main air chamber and a second air hole connected to the bottom cylinder chamber. The valve opening is formed on the inner wall of the valve chamber between the first air hole and the second air hole. An end of the valve bolt forms the end surface. The valve bolt is slidably mounted inside the valve chamber and located opposite to the top of the magnetic piston. Inside the valve chamber the valve bolt has a first position for being lead by the magnetic piston to close the valve opening and a second position for being driven by the high-pressure air inside the top cylinder chamber to open the valve opening. The top of the magnetic piston has a magnetic substance opposite to the opening.

Each of the two nail-pushing rod restoring apparatuses further allows the opening to interconnect the bottom of the valve chamber and the top of the top cylinder chamber. Each of the first air hole and the second air hole is formed on a lateral side of the valve chamber.

Each of the two nail-pushing rod restoring apparatuses further allows the valve bolt to be mounted slidably in the valve chamber and along the nail-pushing axis of the nail gun. When the piston moves to the top of the cylinder, the piston leads the valve bolt to move along the nail-pushing direction. The high-pressure air inside the top cylinder chamber is for driving the valve bolt to move against the nail-pushing direction.

Each of the two nail-pushing rod restoring apparatuses further allows the inner wall on the top of the gun body to have a cushion exposed inside the top cylinder chamber. The valve chamber is located inside the cushion, and the bottom of the cushion forms a contracting neck that interconnects the opening and the top cylinder chamber. Through the opening and the neck, the bottom of the valve bolt is exposed on the top of the top cylinder chamber, and the bottom of the valve bolt is stopped by the inner rim of the neck at the first position.

Each of the two nail-pushing rod restoring apparatuses further allows the inner wall of the valve chamber to form a ring face facing the piston. The outer wall of the valve bolt forms a ring rib, and the valve bolt follows the ring rib to be stopped by the ring face at the second position.

Each of the two nail-pushing rod restoring apparatuses further includes a main air passage and a trigger valve. The main air passage is formed inside the gun body and connected to the main air chamber. The return air passage is connected to the main air passage. The trigger valve is mounted on the gun body and on the main air passage, for opening and closing the main air passage to allow high-pressure air to enter into the main air passage so as to drive the nail gun to shoot nails.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view according to a first embodiment of the present invention;

FIG. 2 is a cross-sectional and partially enlarged view of the gun body of FIG. 1;

FIG. 3 is an explosive view of the magnetic valve of FIG. 1;

FIG. 4 is a cross-sectional and partially enlarged view of the valve chamber of FIG. 2;

FIG. 5 is a cross-sectional and partially enlarged view of the magnetic valve bolt of FIG. 2;

FIG. 6 is a cross-sectional and partially enlarged view of the piston and magnetic valve bolt of FIG. 2;

FIG. 7 shows the piston and magnetic valve bolt of FIG. 6 together with other adjacent nail gun components;

FIG. 8 shows a next operation state of FIG. 2;

FIG. 9 shows a next operation state of FIG. 6;

FIG. 10 shows a next operation state of FIG. 9;

FIG. 11 shows a next operation state of FIG. 8;

FIG. 12 is a cross-sectional view according to a second embodiment of the present invention; and

FIG. 13 is a cross-sectional view according to a third embodiment of the present invention.

### DETAILED DESCRIPTION

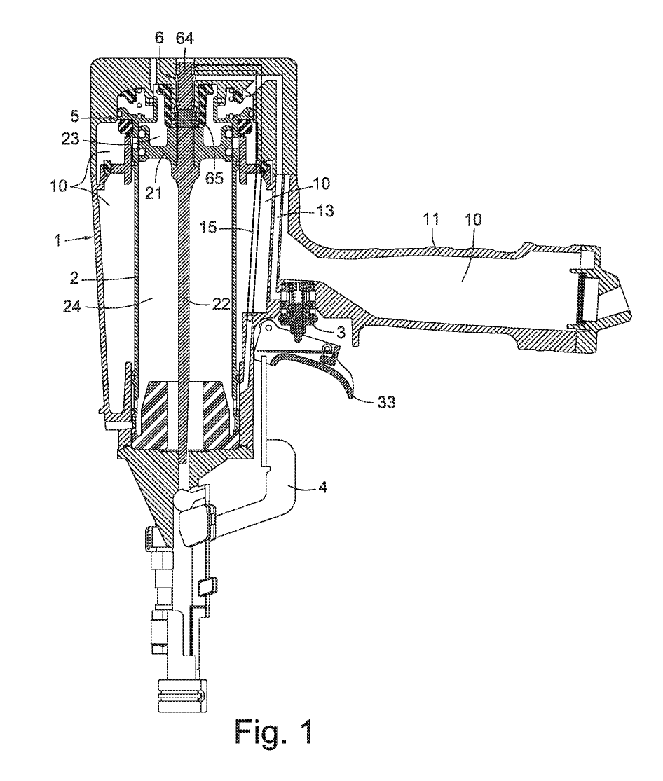

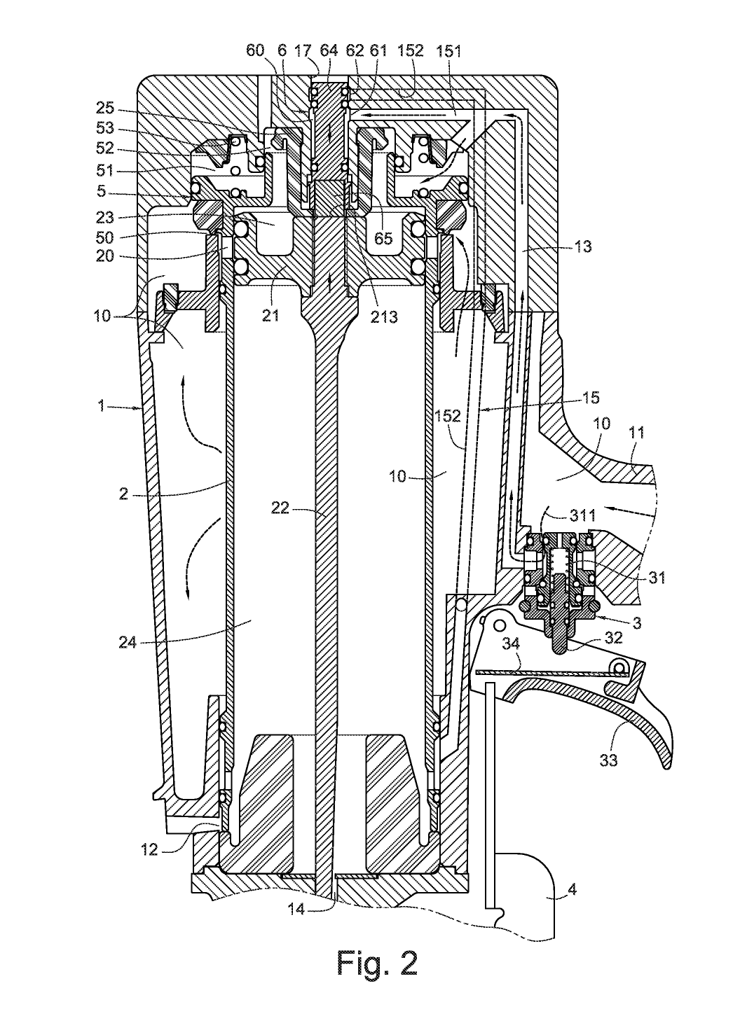

FIG. 1 and FIG. 2 are a cross-sectional view according to a first embodiment of the present invention and a cross-sectional and partially enlarged view of the gun body of FIG. 1, respectively. They illustrate a nail-pushing rod restoring apparatus for a pneumatic nail gun. The nail-pushing rod restoring apparatus includes a piston 21 (which is set inside a gun body 1 of the pneumatic nail gun), a return air passage 15, and a magnetic valve 6. A cylinder 2 is set inside the gun body 1. In this embodiment, the cylinder 2 is a movable cylinder. The piston 21 is slidably mounted inside the cylinder 2. The piston 21's main body can be composed of magnetic metal (such as iron), forming an end surface 213 on the top of the piston 21 that is suitable for being lead by magnetic force. The bottom of the piston 21 is connected to a nail-pushing rod 22. The piston 21 divides the interior of the cylinder 2 into a top cylinder chamber 23 and a bottom cylinder chamber 24. Inside the gun body 1 there are several interconnected main air chambers 10 of high-pressure air. These main air chambers 10 scatters between the exterior of the cylinder 2 and the interior of a grasping part 11 on the side of the gun body 1; they concentrate high-pressure air continually coming in from the end portion of the grasping part 11. Around the top of the cylinder 2 there are several main air holes 20 that could connect the main air chambers 10 with the top cylinder chamber 23. The outer wall of the bottom of the gun body 1 has a slidably mounted safety sliding rod 4. The interior of the bottom of the gun body 1 forms an aperture 14 for guiding the nail-pushing rod 22. A head valve 5 is disposed on the top of the cylinder 2.

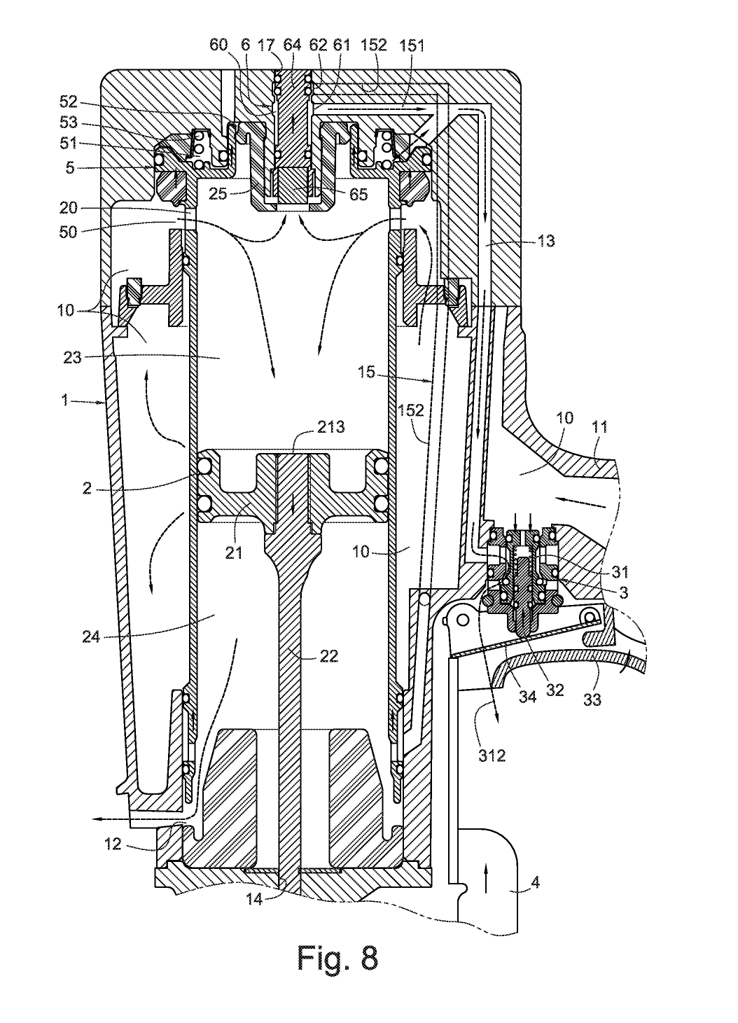

As shown in FIGS. 1 and 2, the head valve 5 of this embodiment can form and be located on the top of the cylinder 2, and move up/down with the cylinder 2 synchronously (please further refer to FIG. 8). The top cylinder chamber 23 is connected to the top inner wall of the gun body 1. The top inner wall of the gun body 1 has a cushion 25 in the center, where the cushion 25 is exposed inside the top cylinder chamber 23 and located opposite to the top of the piston 21. The cushion 25 can cushion and stop the upward movement of the piston 21. The head valve 5 moveably surrounds the outer rim of the cushion 25. The head valve 5 and the top inner wall of the gun body 1 forms a pressure-concentration chamber 51. Between the exterior wall of the head valve 5 (at a position close to the main air holes 20) and the inner wall of the gun body 1, a main valve opening 50 connects the main air chambers 10 and the main air holes 20. Between the top inner wall of the head valve 5 and the exterior wall of the cushion 25 there is an up-exit valve opening 52 that connects the top cylinder chamber 23 and the atmosphere. Between the exterior wall of the bottom of the cylinder 2 and the bottom inner wall of the gun body 1 there is a down-exit valve opening 12 that connects the bottom cylinder chamber 24 and the atmosphere. A compression spring is set in the pressure-concentration chamber 51 along a nail-pushing axis, where the nail-pushing axis refers to the direction in which the nail-pushing rod 22 moves downward for nail pushing.

Inside the gun body 1 there is a main air passage 13, as shown in FIG. 1 and FIG. 2, which is connected between the pressure-concentration chamber 51 and the main air chamber 10 adjacent to the grasping part 11. On a side position of gun body 1 adjacent to the grasping part 11 there is a trigger valve 3. The trigger valve 3 is set on the main air passage 13. A valve cover 31 is slidably mounted in the trigger valve 3, and a trigger valve rod 32 is slidably mounted in the valve cover 31. As shown in FIG. 8, an air inlet passage 311 and an air outlet passage 312 are formed between the valve cover 31 and the inner wall of the trigger valve 3. The trigger valve rod 32 can switch these two passages 311 and 312. The air inlet passage 311 interconnects the main air chamber 10 and the main air passage 13. The air outlet passage 312 interconnects the main air passage 13 and the atmosphere. A trigger 33 is pivoted to a lateral position of the gun body 1 adjacent to the trigger valve 3. An inner trigger 34, which can be pushed by the end of the safety sliding rod 4 and swing accordingly, is pivoted inside the trigger 33. The trigger valve rod 32 extends to a position that can be pushed by the inner trigger 34.

As a result, when the trigger 33 releases the trigger valve rod 32 for downward movement, as shown in FIG. 2, the valve cover 31 will open the air inlet passage 311 and close the air outlet passage 312. The high-pressure air in the main air chamber 10 will pass into the pressure-concentration chamber 51 through the air inlet passage 311 and the main air passage 13, and drive the head valve 5 and cylinder 2 to move downward. The downward movement will open the up-exiting valve opening 52 and close the main valve opening 50 and down-exiting valve opening 12. During this period, the spring 53 helps the high-pressure air to drive the downward movement of the head valve 5 and the cylinder 2. When the trigger 33 pulls the trigger valve rod 32 to move upward, as shown in FIG. 8, the valve cover 31 will open the air outlet passage 312 and close the air inlet passage 311, so that the high-pressure air in the pressure-concentration chamber 51 will leak into the atmosphere through the main air passage 13 and the air outlet passage 312. This causes the high-pressure air in the main air chamber 10 around the cylinder 2 to drive the head valve 5 and cylinder 2 upward. This upward movement will close the up-exiting valve opening 52 and open the main valve opening 50 and the down-exiting valve opening 12. The opened main valve opening 50 allows the high-pressure air in the main air chamber 10 to enter the top cylinder chamber 23 and drive the nail-pushing rod 22 to move downward with the piston 21 for nail-pushing.

The above-mentioned arrangement of the cylinder 2, trigger valve 3, safety sliding rod 4, and head valve 5 represents only a preferred embodiment but does not limit the scope of the present invention. In fact, even with the safety sliding rod 4 and the inner trigger 34 being excluded, through pressing or releasing the trigger 33, the trigger valve rod 32 can still be switched to control the high-pressure air to drive the upward/downward movement of the cylinder 2. Furthermore, the cylinder 2 can be either a movable or a fixed one. In other words, the scope of the present invention also covers nail guns that are equipped with a fixed cylinder and use a trigger valve to control high-pressure air to drive nail-pushing.

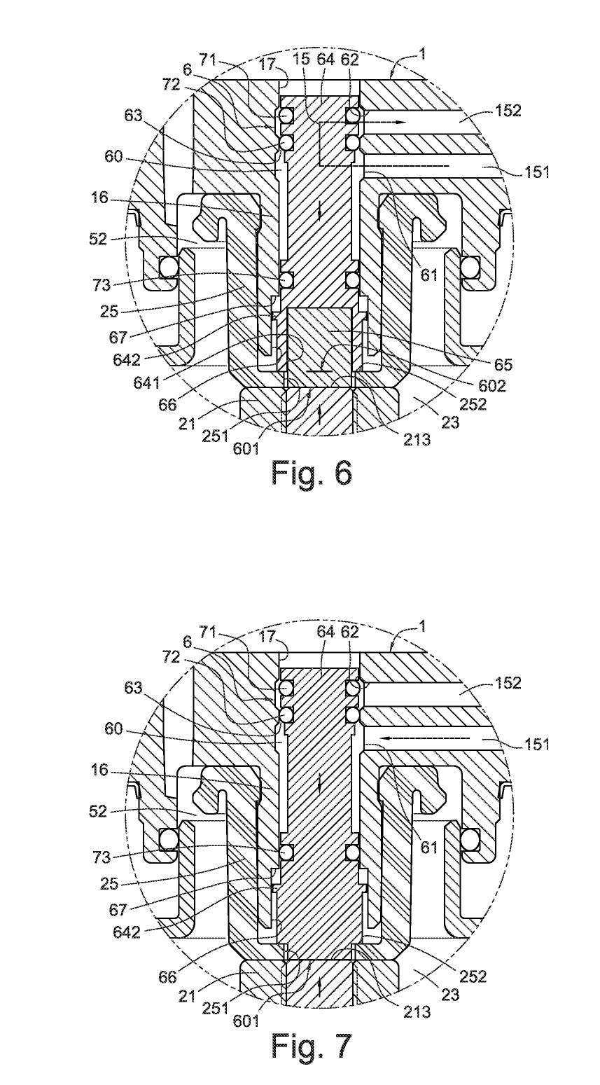

Based upon above and as shown in FIG. 1 and FIG. 2, the return air passage 15 is connected between the main air chamber 10 and the bottom cylinder chamber 24. The return air passage 15 passes through inside of the gun body 1 above the cylinder 2. The magnetic valve 6 is located inside the gun body 1 above the cylinder 2, and on the return air passage 15 (as shown in FIG. 6). As FIG. 10 further indicates, the magnetic valve 6 can control the opening and closing of the return air passage 15. The bottom of the magnetic valve 6 is exposed inside the top cylinder chamber 23 and opposite to the end surface 213 on the top of the piston 21. In a more specific embodiment, the inner wall at the top of the gun body 1 extends towards the cylinder 2 to form a protruding part 16. The cushion 25 covers the bottom of the protruding part 16. The return air passage 15 passes through the protruding part 16 and is connected to an end of the main air passage 13 that is adjacent to the head valve 5. The magnetic valve 6 is slidably mounted inside the protruding part 16 and located in the pre-existing space inside the gun body 1 at the inner side of the head valve 5. The magnetic valve 6 further divides the return air passage 15 into a front air passage 151 that is connected to an end of the main air passage 13 that is adjacent to the head valve 5, and a rear air passage 152 that is connected to the bottom cylinder chamber 24.

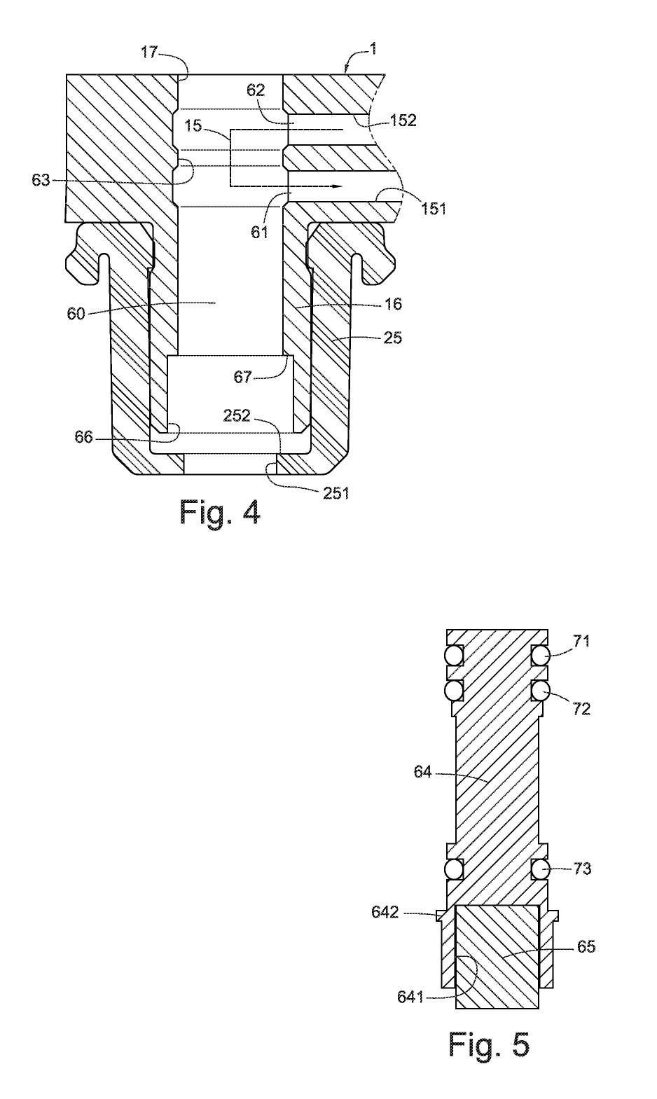

The magnetic valve 6 includes a valve chamber 60, a valve opening 63, and a magnetic valve bolt 64. As shown in FIG. 2, the valve chamber 60 is inside the gun body 1 and above the cylinder 2. More specifically, as shown in FIG. 4 and FIG. 6, the valve chamber 60 is formed inside the protruding part 16, and located inside the cushion 25. The bottom of the protruding part 16 forms an opening 66 that connects the bottom of the valve chamber 60. The bottom of the cushion 25 forms a contracting neck 251 that is opposite to and below the opening 66. The neck 251 interconnects the opening 66 and the top cylinder chamber 23. The top of the gun body 1 forms an air vent 17 that interconnect the top of the valve chamber 60 and the atmosphere. By the side inner wall of the valve chamber 60, the front air passage 151 of the return air passage 15 forms a first air hole 61. Through the front air passage 151, the first air hole 61 is connected to the main air chamber 10. By the side inner wall of the valve chamber 60 and along the nail-pushing axis, the rear air passage 152 of the return air passage 15 forms a second air hole 62 that is adjacent to the first air hole 61. Through the rear air passage 152, the second air hole 62 is connected to the bottom cylinder chamber 24. In this embodiment, the first air hole 61 is underneath the second air hole 62. The valve opening 63 is formed on the inner wall of the valve chamber 60 between the first air hole 61 and the second air hole 62. This exemplary arrangement allows the return air passage 15 to be adjacent to the edge of the top exterior wall of the gun body 1, and the valve chamber 60 to be located inside the top of the gun body 1. This arrangement can help simplify the modeling and drilling-processing of the gun body 1.

The magnetic valve bolt 64 can be in the shape of a cylindrical valve rod, slidably mounted inside the valve chamber 60 along the nail-pushing axis (as shown in FIG. 4 and FIG. 6), and located opposite to the above of the end surface 213 at the top of the piston 21. In a more specific embodiment, as shown in FIG. 5, the bottom of the magnetic valve bolt 64 has a notch 641 that opens towards the piston 21's direction. Furthermore, the notch 641 is embedded with a magnetic substance 65, which could be a magnet. The magnetic substance 65 is exposed on the top cylinder chamber 23 through the opening 66 and the neck 251. In another more specific embodiment, as shown in FIG. 7, the magnetic valve bolt 64 is itself a single magnet. Through the opening 66 and the neck 251, the bottom of the magnetic valve bolt 64 is exposed on the top of the top cylinder chamber 23. In another example, the body of the piston 21 is composed of non-magnetic metal (such as aluminum), and a magnetic metal is embedded in the top of the piston 21 so that the top of the piston 21 could form the end surface 213.

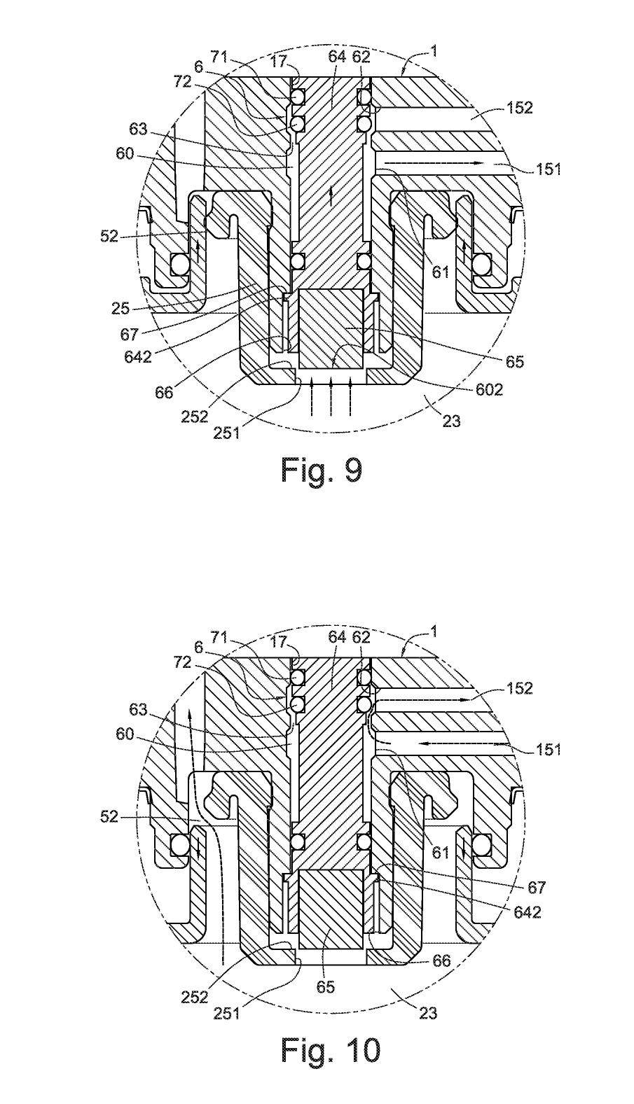

As shown in FIG. 2 and FIG. 6, after the piston 21 moves up to the top inside the cylinder 2 and is at a position ready for downward nail-pushing, the bottom of the magnetic valve bolt 64 of the magnetic valve 6 can be lead by the piston 21 inside the top of the cylinder 2. This can cause the magnetic valve bolt 64 to move along the nail-pushing direction and the bottom of the magnetic valve bolt 64 to become adjacent to or touch the end surface 213 at the top of the piston 21. Here the nail-pushing direction means the direction towards which the nail-pushing rod 22 is moving for nail-pushing. As shown in FIG. 8 and FIG. 9, when the piston 21 is moving downward and away from the magnetic valve 64, the bottom of the magnetic valve 64 can be driven by the high-pressure air inside the top cylinder chamber 23, so that the magnetic valve bolt 64 can move against the nail-pushing direction. In other words, the direction in which the magnetic valve bolt 64 moves is opposite to the direction in which the nail-pushing rod 22 moves for nail-pushing. Thus, inside the valve chamber 60, the magnetic valve bolt 64 has a first position 601 where it can be lead by the piston 21 to close the valve opening 63, and a second position 602 where it can be driven by the high-pressure air inside the top cylinder chamber 23 to open the valve opening 63. As a result, the magnetic valve 6 can open and close the return air passage 15.

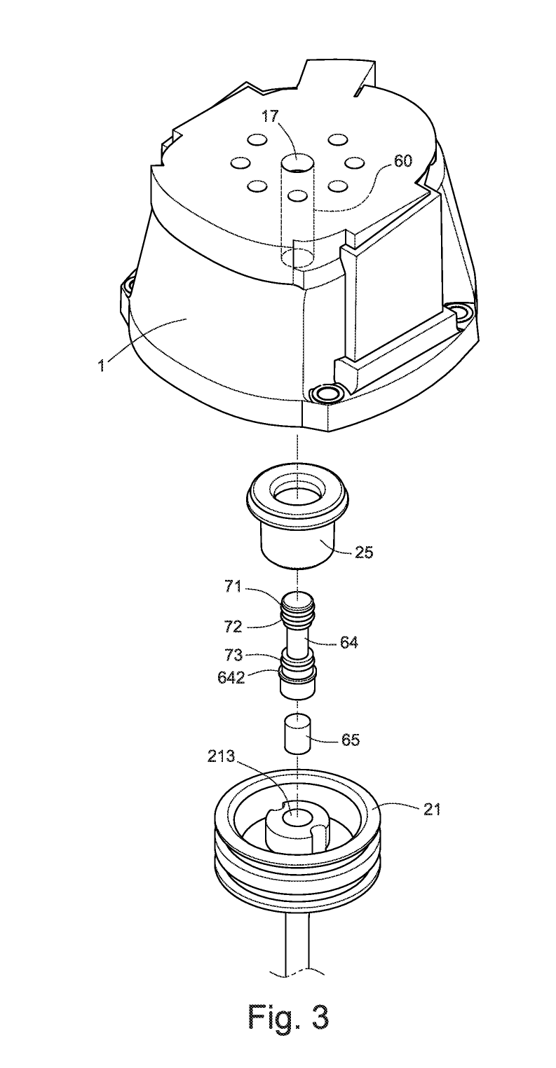

As shown in FIG. 4 and FIG. 6, the inner face of the neck 251 of the cushion 25 forms a ring face 252 opposite to the piston 21. The bottom of the magnetic valve bolt 64 can be stopped by the inner ring face of the neck 251 at the first position 601. The inner wall of the valve chamber 60 forms a ring face 67 facing the piston 21. As shown in FIG. 3 and FIG. 5, the outer wall of the magnetic valve bolt 64 forms a ring rib beneath the ring face 67. With the ring rib 642, the magnetic valve bolt 64 can be stopped by the ring face 67 at the second position 602.

As shown in FIG. 3 and FIG. 5, from top to bottom, the magnetic valve bolt 64 has a top air-blocking ring 71, a middle air-blocking ring 72, and a bottom air-blocking ring 73. When the magnetic valve bolt 64 is at the first position 601, as shown in FIG. 6, the middle air-blocking ring 72 lies in the valve chamber 60 between the first air hole 61 and the second air hole 62, and closes the valve opening 63. In addition, the top air-blocking ring 71 opens up the rear air passage 152 to the atmosphere through the air vent 17. When the magnetic valve bolt 64 is at the second position 602, as shown in FIG. 9, the middle air-blocking ring 72 opens the valve opening 63, interconnects the front air passage 151 and the rear air passage 152. The top air-blocking ring 71 prevents the valve chamber 60 from connecting to the atmosphere through the air vent 17. At the same time, the bottom air-blocking ring 73 lies in the valve chamber 60 between the first air hole 61 and the opening 66.

The above-mentioned structure can implement the present invention, especially when the user does not press the safety sliding rod 4 upward and does not press the trigger 33 (as shown in FIG. 2). The high-pressure air in the main air chamber 10 drives the valve cover 31 to open the air inlet passage 311 and close the air outlet passage 312. This allows the high-pressure air in the main air chamber 10 to enter the pressure-concentration chamber 51 through the air inlet passage 311 and the main air passage 13 to cumulate pressure. As a result, the head valve 5 will be driven downward to open the up-exiting valve opening 52 and close the main valve opening 50 and the down-exiting valve opening 12. At the same time, the piston 21 remains inside the top of the cylinder 2, and the bottom of the magnetic valve bolt 64 is lead by the end surface 213 at the top of the piston 21. As shown in FIG. 6, the magnetic valve bolt 64 will move along the nail-pushing direction, and then will be stopped at the first position 601 by the inner ring face 252 of the neck 251 of the cushion 25. As a result, the high-pressure air in the main air passage 13 is prevented from leaking into the atmosphere through the front air passage 151, the valve opening 63, and the rear air passage 152. The bottom cylinder chamber 24 is connected to the atmosphere through the rear air passage 152 and the air vent 17.

When a user presses the safety sliding rod 4 upward and pulls the trigger 33, as shown in FIG. 8, the trigger 33 will trigger the trigger valve rod 32 to open the air outlet passage 312 and close the air inlet passage 311. As a result, the high-pressure air in the pressure-concentration chamber 51 will leak to the atmosphere through the main air passage 13 and the air outlet passage 312. The high-pressure air in the main air chamber 10 surrounding the cylinder 2 will drive the head valve 5 upward to close the up-exiting valve opening 52 and open the main valve opening 50 and the down-exiting valve opening 12. At this point, the high-pressure air in the main air chamber 10 will flow into the top cylinder chamber 23 through the main valve opening 50 and the main air hole 20, driving the piston 21 to disengage from the magnetic valve bolt 64, and propelling the nail-pushing rod 22 to move downward for nail-pushing. The air in the bottom cylinder chamber 24 will leak into the atmosphere through the down-exiting valve opening 12. During this period, the bottom of the magnetic valve 64 is driving by the high-pressure air in the top cylinder chamber 23, causing the magnetic valve bolt 64 to move against the nail-pushing direction. With the ring rib 642, the magnetic valve bolt 64 will be received and then stopped by the ring face 67 at the second position 602 (as shown in FIG. 9). The front air passage 151 will be connected to the rear air passage 152 through the valve opening 63, and prevent the valve chamber 60 from connecting to the atmosphere through the air vent 17.

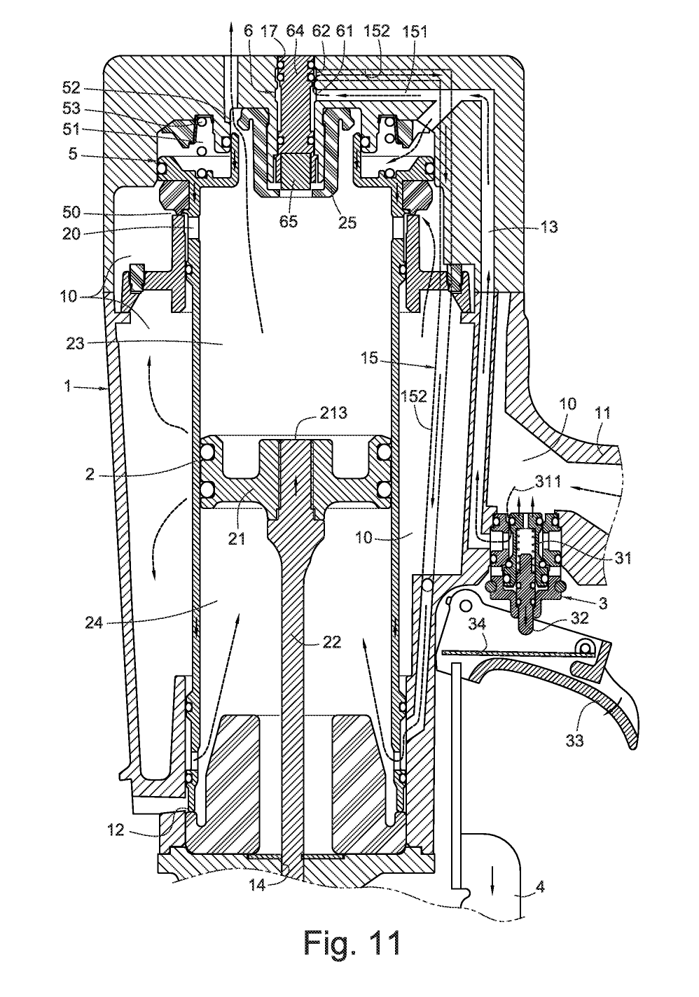

At the moment when the user is releasing the trigger 33 after nail-pushing, as shown in FIG. 11, the trigger 33 will release the trigger valve rod 32 to restore its position. This movement will open the air inlet passage 311, close the air outlet passage 312, and allow high-pressure air in the main air chamber 10 to enter the pressure-concentration chamber 51 through the air inlet passage 311 and the main air passage 13 to accumulate pressure. The cumulated pressure will drive the head valve 5 downward to open the up-exiting valve opening 52, and close the main valve opening 50 and the down-exiting valve opening 12, causing the air in the top cylinder chamber 23 to leak into atmosphere through the up-exiting valve opening 52. At this point, because the piston 21 has not restored its position yet, the magnetic valve bolt 64 is still at the second position 602 (as shown in FIG. 10). As a result, the main air passage 13 is opened up and the high-pressure air therein will pass through the front air passage 151, the valve opening 63, and the rear air passage 152, and enters the bottom cylinder chamber 24, driving the piston 21 and the nail-pushing rod 22 upward for restoration.

At the moment when the piston 21 moves up to the inner top of the cylinder 2 (as shown in FIG. 2), the bottom of the magnetic valve bolt 64 will be lead by the end surface 213 of the piston 21. This will cause the magnetic valve bolt 64 to move downward to the first position 601 (as shown in FIG. 6) to prevent the high-pressure air in the main air passage 13 from passing through the front air passage 151, the valve opening 63, and the rare air passage 152 to the bottom cylinder chamber 24. This will also open up the bottom cylinder chamber 24 so that the air inside can pass through the rare air passage 152 and the air vent 17 to the atmosphere.

In view of the above, the magnetic valve 6 can be disposed inside the top of the gun body 1 and above the cylinder 2. This allows the magnetic valve 6 to be located in the pre-existing space of the gun body 1 inside the head valve 5, and reduces the complicity in modeling and drilling-processing the gun body 1. Furthermore, by reducing the gun body 1's volume while maintaining the cylinder pressure and volume, the nail gun will cost less and function better. In addition, this design is beneficial to the interaction between the magnetic valve 6 and the piston 21, which can attract each other through magnetic force. Through the magnetic valve 6, the piston 21 can control the open and close timing of the return air passage 15. This timing control ensures the operation stability of the magnetic valve 6, which is under the piston 21's control. Furthermore, because the single magnetic valve 6 is used to control the timing that the high-pressure air at a constant pressure inside the main air chamber 10 passes to the bottom cylinder chamber 24, the piston 21's function will not be negatively affected by back pressure. On one hand, this increases the speed and stability of the nail-pushing rod 22 when it is moving upward with the piston 21 to restore its position. On the other hand, this will not sacrifice the energy of the nail-pushing rod 22 when it is moving downward with the piston 21 to shoot a nail. As a result, the nail gun can have a superior efficiency and smoothness in successive nailing.

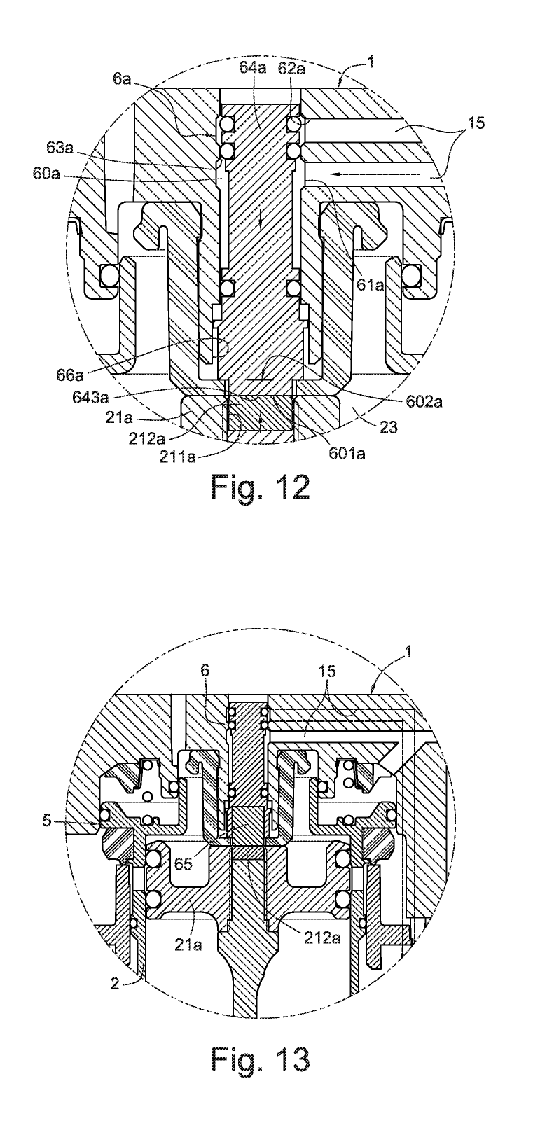

FIG. 12 is a cross-sectional view according to a second embodiment of the present invention, illustrating a nail-pushing rod restoring apparatus for a pneumatic nail gun. The nail-pushing rod restoring apparatus includes a magnetic piston 21a, a return air passage 15, and a valve 6a. The bottom of the magnetic piston 21a is connected to a nail pushing rod 22 (please refer to FIG. 2). The return air passage 15 is connected between the main air chamber 10 and the bottom cylinder chamber 24. The return air passage 15 also passes inside the gun body 1 above the cylinder 2. The valve 6a is disposed inside the gun body above the cylinder 2, and located on the return air passage 15 for controlling the open and close of the return air passage 15. The valve 6a's body can be composed of magnetic metal (such as iron). The bottom of the valve 6a forms an end surface 643a that is suitable for being lead by magnetic force. The end surface 643a is exposed inside the top cylinder chamber 23 and opposite to the top of the magnetic piston 21a. The valve 6a includes a valve chamber 60a, a valve opening 63a, and a valve bolt 64a. The valve chamber 60a is formed inside the gun body above the cylinder 2. An opening 66a interconnects the valve chamber 60a and the top cylinder chamber 23. The return air passage 15 forms a first air hole 61a and a second air hole 62a on the inner wall of the valve chamber 60a. The first air hole 61a is connected to the main air chamber 10 through the main air passage 13 and the trigger valve 3; the second air hole 62a is connected to the bottom cylinder chamber 24. The valve opening 63a is formed on the inner wall of the valve chamber 60a between the first air hole 61a and the second air hole 62a. The bottom of the valve bolt 64a forms the end surface 643a. The valve bolt 64a is slidably mounted inside the valve chamber 60a along the nail gun's nail-pushing axis and opposite to the top of the magnetic piston 21a. Inside the valve chamber 60a there is a first position 601a at which the valve bolt 64a can be lead by the magnetic piston 21a to close the valve opening 63a. Inside the valve chamber 60a there is also a second position at which the valve bolt 64a can be driven by the high-pressure air in the top cylinder chamber 23 to open the valve opening 63a.

The top of the magnetic piston 21a forms a notch 211a that is opened towards the direction of the valve bolt 64a (as shown in FIG. 12). The notch 211a is embedded with a magnetic substance 212a, which is located opposite and beneath the opening 66a. The magnetic substance 212a can be a magnet. Furthermore, the valve 6a's body can be made of a non-magnetic metal (such as aluminum). A magnetic metal is buried in the bottom of the valve bolt 64a, so that the bottom of the valve bolt 64a forms the end surface 643a. Other elements of this second embodiment are the same as their counterparts in the first embodiment.

Based upon above, the bottom of the valve bolt 64a can be lead by the magnetic piston 21a when the magnetic piston 21a moves to the top of the cylinder 2 (as shown in FIG. 12). The valve bolt 64a will move towards the magnetic piston 21a to the first position 601a, so as to close the return air passage 15. When the nail-pushing rod 22 is moving down for nail-pushing, the valve 6a will be driven by the high-pressure air in the top cylinder chamber 23 to move against the magnetic piston 21a to the second position 602a (please refer to FIG. 9), so as to open the return air passage 15. The return air passage 15 then guides the high-pressure air in the main air chamber 10 to reach the bottom cylinder chamber 24 (please refer to FIG. 10 and FIG. 11). The high-pressure air will drive the nail-pushing rod 22, which has performed nail-pushing, to move upward for restoration. The other aspects of this second embodiment are the same as their counterparts in the first embodiment.

In view of the above, the valve 6a can be disposed inside the top of the gun body 1 and above the cylinder 2. This allows the valve 6a to be located in the pre-existing space of the gun body 1 inside the head valve 5, and reduces the complicity in processing the gun body 1. Furthermore, by reducing the gun body 1's volume while maintaining the cylinder pressure and volume, the nail gun will cost less and function better. In addition, this design is beneficial to the reciprocal attraction between the valve 6a and the magnetic piston 21a. Thus, the magnetic piston 21a can better control the valve 6a, which then can better control the open and close timing of the return air passage 15. This timing control ensures the operation stability of the valve 6a, which is under the magnetic piston 21a's control. Furthermore, because the single valve 6a is used to control the timing that the high-pressure air at a constant pressure inside the main air chamber 10 passes to the bottom cylinder chamber 24, the nail-pushing rod 22 will have a better speed and stability when moving upward with the magnetic piston 21a to restore the original position. As a result, the nail gun can have a superior efficiency and smoothness in successive nailing.

FIG. 13 is a cross-sectional view according to a third embodiment of the present invention. This embodiment illustrates that the magnetic valve 6 of the first embodiment and the magnetic piston 21a of the second embodiment can be used together to increase the stability that the magnetic piston 21a controls the magnetic valve 6 to operate. Elements of the third embodiment not shown in FIG. 13 are the same as their counterpart in the first and/or second embodiments.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A nail-pushing rod restoring apparatus for a pneumatic nail gun, comprising:
a piston, the top of the piston having an end surface suitable for being lead by magnetic force, the bottom of the piston having a nail-pushing rod;
a return air passage, connected between a high-pressure main air chamber inside a gun body of the nail gun and a bottom cylinder chamber of a cylinder, the return air passage passing above the cylinder and through the interior of the gun body; and
a magnetic valve, disposed inside the gun body above the cylinder and located on the return air passage, for controlling the opening and closing of the return air passage, an end of the magnetic valve being exposed inside a top cylinder chamber of the cylinder and opposite to the end surface of the piston, the magnetic valve being lead by the piston to close the return air passage when the piston moves to the top of the cylinder, the magnetic valve being driven by the high-pressure air inside the top cylinder chamber to open the return air passage when the nail-pushing rod moves downward.

2. The nail-pushing rod restoring apparatus of claim 1, wherein the magnetic valve comprises:
a valve chamber, formed inside the gun body above the cylinder, an opening interconnecting the valve chamber and the top cylinder chamber, on the inner wall of the valve chamber, the return air passage forming a first air hole connecting the main air chamber and forming a second air hole connecting the bottom cylinder chamber;
a valve opening, forming on the inner wall of the valve chamber between the first air hole and the second air hole; and
a magnetic valve bolt, mounted inside the valve chamber slidably and located opposite to the end surface at the top of the piston, inside the valve chamber the magnetic valve bolt having a first position for being lead by the piston to close the valve opening and a second position for being driven by the high-pressure air inside the top cylinder chamber to open the valve opening.

3. The nail-pushing rod restoring apparatus of claim 2, wherein the bottom of the magnetic valve bolt has a magnetic substance, through the opening the magnetic substance is exposed on the top of the top cylinder chamber.

4. The nail-pushing rod restoring apparatus of claim 2, wherein the opening interconnects the bottom of the valve chamber and the top of the top cylinder chamber, each of the first air hole and the second air hole is formed on a lateral side of the valve chamber.

5. The nail-pushing rod restoring apparatus of claim 2, wherein the valve bolt is mounted slidably in the valve chamber and along the nail-pushing axis of the nail gun, when the piston moves to the top of the cylinder the piston leads the valve bolt to move along the nail-pushing direction, the high-pressure air inside the top cylinder chamber is for driving the valve bolt to move against the nail-pushing direction.

6. The nail-pushing rod restoring apparatus of claim 2, wherein inner wall on the top of the gun body has a cushion exposed inside the top cylinder chamber, the valve chamber is located inside the cushion, and the bottom of the cushion forms a contracting neck that interconnects the opening and the top cylinder chamber, through the opening and the neck, the bottom of the valve bolt is exposed on the top of the top cylinder chamber, and the bottom of the valve bolt is stopped by the inner rim of the neck at the first position.

7. The nail-pushing rod restoring apparatus of claim 2, wherein the inner wall of the valve chamber forms a ring face facing the piston, the outer wall of the valve bolt forms a ring rib, and the valve bolt follows the ring rib to be stopped by the ring face at the second position.

8. The nail-pushing rod restoring apparatus of claim 1, further comprising:
a main air passage, formed inside the gun body and connecting to the main air chamber, the return air passage connecting the main air passage; and
a trigger valve, mounted on the gun body and on the main air passage, for opening and closing the main air passage to allow high-pressure air to enter into the main air chamber so as to drive the nail gun to shoot nails.

9. A nail-pushing rod restoring apparatus for a pneumatic nail gun, comprising:
a magnetic piston, having a nail-pushing rod in the bottom;
a return air passage, connected between a high-pressure main air chamber inside a gun body of the nail gun and a bottom cylinder chamber of a cylinder, the return air passage passing inside the gun body above the cylinder; and
a valve, disposed above the cylinder, inside the gun body, and located on the return air passage, for controlling the opening and closing of the return air passage, an end of the valve having an end surface suitable for being lead by magnetic force, the end surface being exposed inside a top cylinder chamber of the cylinder and opposite to the end surface of the magnetic piston, the valve being lead by the piston to close the return air passage when the piston is moving to the top of the cylinder, the valve being driven by the high-pressure air inside the top cylinder chamber to open the return air passage when the nail-pushing rod is moving downward.

10. The nail-pushing rod restoring apparatus of claim 9, wherein the valve comprises:
a valve chamber, formed inside the gun body above the cylinder, an opening interconnecting the valve chamber and the top cylinder chamber, on the inner wall of the valve chamber, the return air passage forming a first air hole connecting the main air chamber and forming a second air hole connecting the bottom cylinder chamber;
a valve opening, formed on the inner wall of the valve chamber between the first air hole and the second air hole; and
a valve bolt, an end of the valve bolt forming the end surface, the valve bolt being slidably mounted inside the valve chamber and located opposite to the top of the magnetic piston, inside the valve chamber the valve bolt having a first position for being lead by the magnetic piston to close the valve opening and a second position for being driven by the high-pressure air inside the top cylinder chamber to open the valve opening.

11. The nail-pushing rod restoring apparatus of claim 10, wherein the top of the magnetic piston has a magnetic substance opposite to the opening.

12. The nail-pushing rod restoring apparatus of claim 10, wherein the opening interconnects the bottom of the valve chamber and the top of the top cylinder chamber, each of the first air hole and the second air hole is formed on a lateral side of the valve chamber.

13. The nail-pushing rod restoring apparatus of claim 10, wherein the valve bolt is mounted slidably in the valve chamber and along the nail-pushing axis of the nail gun, when the piston moves to the top of the cylinder the piston leads the valve bolt to move along the nail-pushing direction, the high-pressure air inside the top cylinder chamber is for driving the valve bolt to move against the nail-pushing direction.

14. The nail-pushing rod restoring apparatus of claim 10, wherein inner wall on the top of the gun body has a cushion exposed inside the top cylinder chamber, the valve chamber is located inside the cushion, and the bottom of the cushion forms a contracting neck that interconnects the opening and the top cylinder chamber, through the opening and the neck, the bottom of the valve bolt is exposed on the top of the top cylinder chamber, and the bottom of the valve bolt is stopped by the inner rim of the neck at the first position.

15. The nail-pushing rod restoring apparatus of claim 10, wherein the inner wall of the valve chamber forms a ring face facing the piston, the outer wall of the valve bolt forms a ring rib, and the valve bolt follows the ring rib to be stopped by the ring face at the second position.

16. The nail-pushing rod restoring apparatus of claim 9, further comprising:
a main air passage, formed inside the gun body and connecting to the main air chamber, the return air passage connecting the main air passage; and
a trigger valve, mounted on the gun body and on the main air passage, for opening and closing the main air passage to allow high-pressure air to enter into the main air chamber so as to drive the nail gun to shoot nails.
